(19) United States
(12) Patent Application Publication
(10) Pub. No.: US 2022/0348466 A1
(43) Pub. Date: Nov. 3, 2022

(54) Columnar-carbon and Graphene-Plate Lattice Composite used as a Structural Building System Material

(71) Applicant: Graphul Industries LLC, (US)

(72) Inventor: Brian Michael Parker, Lockport, IL (US)

(21) Appl. No.: 17/220,581

(22) Filed: Apr. 1, 2021

Related U.S. Application Data
(60) Provisional application No. 63/003,526, filed on Apr. 1, 2020.

(51) Int. Cl. C01B 32/194; C01B 32/16; B01J 19/12

(52) U.S. Cl. CPC C01B 32/194; C01B 32/16; B01J 19/121; B82Y 30/00

(57) ABSTRACT

The invention consists of pristine graphene and fullerenes.

### BACKGROUND

No relevant prior art exists.

### BRIEF SUMMARY

The invention as described in the abstract and claims.

### BRIEF DESCRIPTION OF DRAWINGS

FIG. 1 shows a method in accordance with one or more embodiments of the invention.

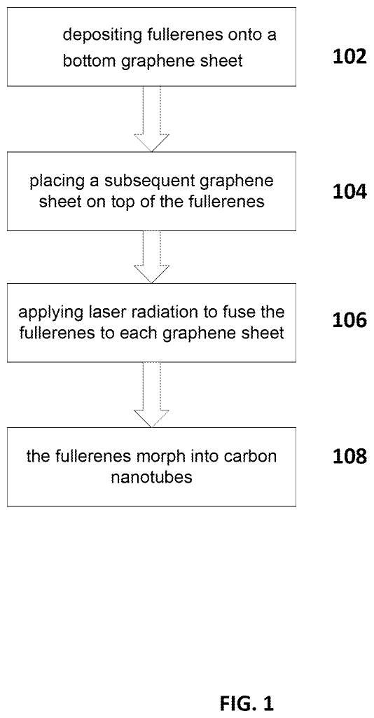

### DETAILED DESCRIPTION

A detailed description is as follows:

### BRIEF DESCRIPTION

A structural building material has been invented comprised of graphene plates and columnar-carbon pillars. This material exhibits structural/mechanical propensities that supersede that of steel, steel-reinforced concrete, or any other conventional structural composite. The structural properties of this material can be tuned by changing the quantity of layers and the spacing distance between carbon columns.

Graphene and carbon nanotubes inherently possess tremendous structural qualities. In addition, they are both non-corrosive and exhibit semi-conductive properties. Combining these different forms of carbon together in alternating layers allows for continuation of strength and conductivity. The tensile properties of graphene and fullerenes are over 200 times greater than that of steel whilst being 15% or less dense than steel. Therefore, this new structural material should be orders of magnitude lighter and require less material than its equivalent steel, concrete, or composite equals. For example, it is our estimation that approximately one pound of this graphene and carbon nanotube composite is structurally equivalent to one ton of steel.

LAMMPS (Large-scale Atomic/Molecular Massively Parallel Simulator) analysis performed on this new material has indicated the ideal spacing of columns at intervals of 0.81 nanometers and indirectly staggered via honeycomb patterning, layer by layer, for optimal structural performance.

Components of Invention

The invention consists of pristine graphene and fullerenes. These materials are placed together using patent-pending nanorollers that determine the spacing of fullerenes onto the pristine graphene sheets. Once fullerenes have been deposited onto a bottom graphene sheet, another subsequent sheet of graphene is then placed on top of the fullerenes which then undergoes laser radiation to fuse the fullerenes to each respective graphene sheet (fullerenes morph into carbon nanotubes). This process is repeated with the nanorollers applying fullerenes to the top of the already joined portion of material until the desired thickness is achieved. Another method for achieving the same results is to layer the composite in its entirety and then apply laser ablation to create a fully joined composite. Two factors allow for the tunability of the composite's inherent structural capacities; 1.) Thickness, and 2.) Spacing and location of fullerenes/carbon nanotubes. Based on MD (LAMMPS computer simulation) analysis, the most optimal spacing of columnar carbon nanotubes for exhibiting the greatest mechanical propensities is 0.81 nm. For example, creation of a material with greater structural characteristics will require greater thicknesses. The resultant product is a graphene and columnar-carbon composite material that displays superior structural qualities.

Improvement Compared to Products of Today

This invention surpasses the structural qualities of today's available building systems technologies. What once required heavy machinery to lift and place now can be done by man or woman. The non-corrosive nature of the material will allow it to endure for much greater timeframes than that of steel or concrete which are prone to either rusting or spalling. Furthermore, the fact that the material is semi-conductive will allow for an electrical current to be placed throughout it. This could be used for deicing or magnetic levitation. The future uses of this product are endless and may include space elevators, cross oceanic bridgeways, or self-levitating highways. The immediate use for the material is to revolutionize the building systems and construction industries by becoming the material of choice for all construction projects.

Date of Conception

The date of conception for this invention was Apr. 2, 2019. Additional MD (computer simulation) analysis results have yielded enhanced understanding of this structural composite since the conception of this material and thereby a need to patent based upon these specific composite attributes. The idea had been theorized as early as January of 2019. For matter of record, a trademark was applied for by the inventor, Brian M Parker, that relates directly to this invention.

No written publications, oral presentations, or grant applications exist in regards to this invention.

Dates of Importance

First planned oral presentation of invention at seminars, meetings, conferences, etc.: Apr. 2, 2020 or later

Conducting proof of concept with test specimen Apr. 2, 2020 thru Apr. 2, 2021

First planned publication: Invention will be publicized when it is ready for entry into the market. No publications are planned for purposes of secrecy as to avoid commercial competition.

First planned demonstration: Subsequent to final research and testing analyses. This is anticipated at the end of Q2 in 2021.

Background Research and Prior Art

To the best of my knowledge, no relevant prior art exists. On Apr. 2, 2019 a previous non-provisional patent was submitted by this inventor, Brian Parker, for a similar structural composite but without the knowledge of optimal columnar-carbon spacing intervals. Based upon new data pertaining to the composite, this updated patent was filed to protect the newfound proprietary understanding.

Intended Uses for Invention

The following are intended uses for the invention: structural concrete members, structural steel members, precast concrete structural members, bridges, highways, streets, skyscrapers, sidewalks, foundations, dams, industrial plants, canals, airports, structural composites, aircraft, military equipment, and civil infrastructure.

1. An apparatus comprising:
pristine graphene; and
fullerenes,
wherein the pristine graphene and the fullerenes are placed together using one or more nanorollers configured to determine spacing of the fullerenes onto sheets of the pristine graphene.

2. A method comprising:
depositing fullerenes onto a bottom graphene sheet;
placing a subsequent graphene sheet on top of the fullerenes; and
applying laser radiation to fuse the fullerenes to each graphene sheet, wherein the fullerenes morph into carbon nanotubes.

3. An apparatus as described herein.

4. (canceled)
